(19) United States
(12) Patent Application Publication
(10) Pub. No.: US 2023/0259964 A1
(43) Pub. Date: Aug. 17, 2023

(54) DEVICE FOR PROVIDING MEDIATION SERVICE BETWEEN ADVERTISER AND INFLUENCER BY USING ARTIFICIAL INTELLIGENCE, AND MEDIATION METHOD USING SAME

(71) Applicant: REVUCORPORATION INC., Seoul (KR)

(72) Inventor: Dae Kyu CHANG, Seoul (KR)

(73) Assignee: REVUCORPORATION INC., Seoul (KR)

(21) Appl. No.: 18/018,447

(22) PCT Filed: Jul. 28, 2021
(86) PCT No.: PCT/KR2021/009758

§ 371 Date: Mar. 17, 2023

(30) Foreign Application Priority Data
Jul. 28, 2020 (KR) 10-2020-0094051

(51) Int. Cl. G06Q 30/0242; G06Q 30/0273; G06Q 30/0251

(52) U.S. Cl. CPC G06Q 30/0242; G06Q 30/0273; G06Q 30/0258

(57) ABSTRACT

Provided is a device for providing an influencer mediation service including an advertiser information register receiving information about advertisers, an influencer information register receiving information about influencers, an influencer information collector that collects activity information of the influencer by crawling the content posted by the influencer for each platform, an advertisement result information collection unit that collects advertisement result information of the influencer and evaluation information on the influencer, and an advertisement result information collector that generates an influencer recommendation list suitable for the advertiser based on the information collected by the advertiser information register, the influencer information register, the influencer information collector, and the advertisement result information collector and provides the influencer recommendation list to the advertiser.

### TECHNICAL FIELD

The present invention relates to a device for providing mediation service between advertiser and influencer by using artificial intelligence, and mediation method using same, and more particularly, to an influencer suitable for a product or service to be advertised based on the results of analyzing information about advertisers and activities of influencers. The present invention relates to an influencer mediation system and a mediation method using the same that can provide advertisers with a method to increase advertising effects and at the same time automatically provide advertising items to influencers to provide profits.

### BACKGROUND ART

With the development of communication technology, individuals form a network on the Internet using Internet technology through a PC, thereby playing a role in solving the conventional place and time constraints at the same time. In addition, a service that allows individuals to establish relationships with others in their virtual space on the Internet, that is, services that provide communication and share various information, is emerging. This is called a Social Networking Service (SNS).

Representative types of social network services include video platforms such as Youtube, Internet broadcasting platforms such as Afreeca TV, Twitch TV, and TV Daumpot, portal site platforms such as Naver, Google, Daum, and Yahoo, facebook, Instagram, twitter, and cacao, social media platforms such as story, blog platforms such as Daum Blog, Naver Blog, T Story Blog, and Blog Spot.

On social media platforms, anyone can share information and reviews about a particular brand's products or services, but some consumers have a distinctly more influential voice than other users. The content they create often has similar or even greater effects than direct brand promotion. These social media content creators are called “influencers”. In other words, an influencer refers to a user with high influence within a specific platform. For example, a user with many followers on a social media platform, a user who operates a blog with a large number of visitors, a YouTube user who operates a channel with a large number of subscribers, and the like may correspond to this.

Influencers produce and post their own content, and the content is exposed to many users within the platform. Along with the increase in exposure frequency, other users' interest in things related to influencers, such as products used by influencers, places they enjoy, hobbies, and specialties, is increasing. In addition, the opinions or stories about a particular product that they share have a great influence on other consumers' perception of the brand or purchase decision.

Influencers can use this influence to obtain various benefits. For example, an advertiser commissions influencers to advertise a specific product or service, and the influencers can obtain financial or material benefits in return for the advertisement request. In other words, influencers can be used as one advertising channel by advertisers. Therefore, the number of brands and advertisers interested in influencer marketing continues to increase.

However, in the case of advertising methods through existing influencers, advertisers have to contact influencers individually and request advertisements, which consumes a lot of time and money for advertisers. In addition, it is difficult for advertisers to obtain information about influencers and to predict the effect that can only be obtained by requesting an advertisement from the influencer.

Even if an intermediary platform is used to connect advertisers and influencers, in the case of the prior art, advertisers and influencers are simply connected based on popularity, such as users with a large number of followers or users who operate blogs with a large number of visitors. It was difficult for advertisers to connect influencers with the style they wanted.

In addition, since the influencers passively received advertisements, there was a problem that the effect of advertisements through influencers was hindered because the influencers could not do the kinds of advertisements they wanted to do or the advertisements they could do well.

### DISCLOSURE

### Technical Problem

Therefore, device for providing mediation service between advertiser and influencer by using artificial intelligence, and mediation method using same according to an embodiment is an invention designed to solve the problems described above, the purpose is to mediate the most suitable influencer for advertisers based on information about advertisers and information about influencers.

Specifically, the present invention uses artificial intelligence technology based on information on products or services that advertisers want to advertise, various information on influencers, information on advertising effectiveness of influencers, and feedback information on specific products or services, the purpose is to mediate the optimal influencer suitable for advertisers by using it.

### Technical Solution

A device for providing mediation service between advertiser and influencer by using artificial intelligence according an embodiment may comprise an advertiser information register that receives information about an advertiser, an influencer information register that receives information about an influencer, an influencer information collector that collects activity information of the influencer by crawling the contents posted by the influencer for each platform, an advertisement result information collector that collects advertisement result information of the influencer and evaluation information on the influencer and a recommendation list generator that generates an influencer recommendation list suitable for the advertiser and provides it to the advertiser based on the information collected by the advertiser information register, the influencer information register, the influencer information collector and the advertisement result information collector, wherein the recommendation list generator includes an artificial neural network module performing deep learning by using a trained artificial neural network (ANN) with the information registered by the advertiser information register and the analysis information on the influencer as input values and generating a list of recommended influencers suitable for the advertiser and performing feedback on the list of recommended influencers based on the advertisement activity information and evaluation information collected by an advertisement activity monitoring unit.

The device for providing mediation service between advertiser and influencer by using artificial intelligence is further comprising an influencer analysis information generator generating comprehensive information on the influencers in the recommendation list based on the information collected by the influencer information register, the influencer information collector, and the advertisement result information collector and providing an information generated by comparing the above comprehensive information with all influencers registered in the influencer information register to the advertiser.

The influencer analysis information generator generates the compared information together with information about the passage of time or classifies the information by platform.

The influencer analysis information generator generates information on at least one of influencer's advertising activity amount by platform, advertising platform, advertising history by product or service category, advertising effect by product or service, and cost versus advertising effect by product or service.

The influencer information register is registered an information about at least one of information on the influencer's preferred platform, posting style, activity area, type of filming device, body information, skin information, job information, whether a companion animal is owned, and frequently used key keywords and interests.

The recommendation list generator calculates expected advertising effects for each influencer or platform for a product or service to be advertised and creates a list of recommended influencers in order of highest expected advertising effect.

A method for providing mediation service between advertiser and influencer by using artificial intelligence according another embodiment may comprise receiving by a server registration information about an advertiser, receiving by the server information about an influencer, collecting by the server activity information of the influencer by crawling the content posted by the influencer for each platform, collecting by the server advertisement result information of the influencer and evaluation information on the influencer and generating by the server a recommendation list that generates and provides an influencer recommendation list suitable for the advertiser based on the information about the advertiser and the information about the influencer, wherein generating by the server the recommendation list includes using by the server the information on the advertiser and the information on the influencer as input values, deep learning is performed using a trained artificial neural network (ANN) to generate the list of recommended influencers suitable for the advertiser, and performing by the server feedback on the recommended influencer list based on the advertisement result information and evaluation information.

The method for providing mediation service between advertiser and influencer by using artificial intelligence may further comprise generating by the server comprehensive information about the influencer in the recommendation list and providing by the server information generated by comparing the comprehensive information with all registered influencers to the advertiser.

### Advantageous Effects

A device for providing mediation service between advertiser and influencer by using artificial intelligence, and mediation method using same according to an embodiment, unlike the prior art, it finds and mediates the most suitable influencer for the advertiser based on the information about the advertiser and the information about the influencer, so there is an advantage of maximizing the advertising effect of communicating with the influencer.

In addition, in generating the recommended influencer list, the present invention generates the recommended influencer list using an algorithm in which feedback information on the actual advertisement effect is reflected using artificial intelligence technology rather than the same algorithm, so there is an effect that can mediate the right influencer and more useful for advertisers.

In addition, in providing analyzed information about influencers to advertisers, information that changes over time and comparison information with other influencers is also provided, not singular numbers, so advertisers have the advantage of being able to choose their preferred influencers.

### DESCRIPTION OF DRAWINGS

FIG. 1 is a block diagram showing some components of an advertiser and influencer mediation system using artificial intelligence according to an embodiment.

FIG. 2 is a block diagram showing some components of device for providing influencer mediation service according to an embodiment.

FIG. 3 is a diagram for explaining an artificial neural network module of an influencer mediation service providing apparatus according to an embodiment.

FIG. 4 is a diagram for explaining a training session and an inference session of an artificial neural network module according to an embodiment.

FIG. 5 is a diagram showing the structure of a multi-layer neural network model (deep learning or deep neural network model) according to an embodiment.

FIG. 6 is a diagram illustrating a calculation process in a node of an artificial neural network module according to an embodiment.

FIG. 7 is a diagram illustrating a drop-out method of an artificial neural network module according to an embodiment.

FIG. 8 is a graph showing a ReLU activation function according to an embodiment.

FIGS. 9 to 12 are diagrams illustrating examples of information provided to advertisers in an advertiser and influencer mediation system using artificial intelligence according to an embodiment.

FIG. 13 is a flowchart illustrating an operation flow of mediation service between advertiser and influencer by using artificial intelligence according to an embodiment.

### MODE FOR INVENTION

Hereinafter, embodiments according to the present invention will be described with reference to the accompanying drawings. In adding reference numerals to the components of each drawing, it should be noted that the same components have the same numerals as much as possible, even if they are displayed on different drawings. In addition, in describing an embodiment of the present invention, if it is determined that a detailed description of a related known configuration or function hinders understanding of the embodiment of the present invention, the detailed description thereof will be omitted. In addition, embodiments of the present invention will be described below, but the technical idea of the present invention is not limited or limited thereto and can be modified and implemented in various ways by those skilled in the art.

In addition, terms used in this specification are used to describe embodiments and are not intended to limit and/or limit the disclosed invention. Singular expressions include plural expressions unless the context clearly dictates otherwise.

In this specification, terms such as “include”, “comprise” or “have” are intended to designate that there is a feature, number, step, operation, component, part, or combination thereof described in the specification, but one or the existence or addition of more other features, numbers, steps, operations, components, parts, or combinations thereof is not excluded in advance.

In addition, throughout the specification, when a part is said to be “connected” to another part, this is not only the case where it is “directly connected”, but also the case where it is “indirectly connected” with another element in the middle. Terms including ordinal numbers, such as “first” and “second” used herein, may be used to describe various components, but the components are not limited by the terms.

Hereinafter, with reference to the accompanying drawings, embodiments of the present invention will be described in detail so that those skilled in the art can easily carry out the present invention. And in order to clearly explain the present invention in the drawings, parts irrelevant to the description are omitted.

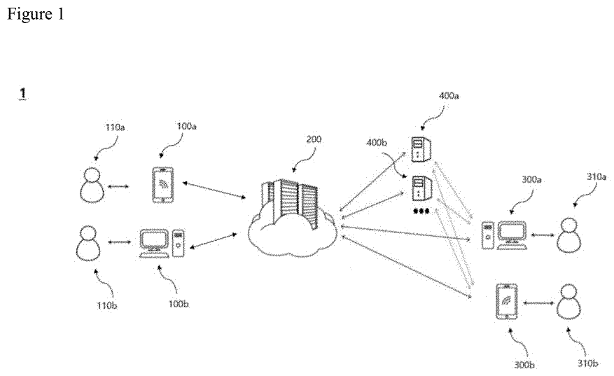

FIG. 1 is a block diagram showing some components of an advertiser and influencer mediation system using artificial intelligence according to an embodiment of the present invention.

Referring to FIG. 1, an advertiser and influencer mediation system using artificial intelligence 1 according to an embodiment may include a terminal device 110 of an advertiser 110, an influencer mediation service providing device 200, and a terminal device 300 of the influencer 310 and the platform system server 400.

The influencer mediation system 1 can mediate advertisement requests between an advertiser 110 and an influencer 310 and monitor the advertisement activities of influencers through the advertiser terminal device 100, the influencer mediation service providing device 200, and the influencer terminal device 300.

The advertiser terminal device 100 may access the influencer mediation service providing device 200 under the control of the advertiser 110. The advertiser terminal device 110 may access the influencer mediation service providing device 200 and search for influencers registered in the corresponding system and information on the influencers.

In addition, the advertiser terminal device 100 may receive a recommendation of an influencer for an advertisement target product or service from the influencer mediation service providing device 200. The advertiser terminal device 100 may select an influencer to request an advertisement under the control of the advertiser and request the advertisement from the influencer mediation service providing device 200. When a result of monitoring or analyzing an influencer's advertising activity is received from the device 200 for providing an influencer mediation service, the advertiser terminal device 100 may display the received monitoring result or analysis result on the screen.

Accordingly, the advertiser terminal device 100 may include a mobile terminal device capable of accessing the influencer mediation service providing device 200 through a dedicated application or a general-purpose application, and includes a computing device. For example, the mobile terminal device may include PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smartphone, smartpad, tablet PC, smart watch), smart glasses, wearable devices, and the like, all types of handheld-based wireless communication devices.

The influencer mediation service providing server 120 analyzes the activities of the influencer 310 active on each platform (ex, video platform, internet broadcasting platform, portal site platform, social media platform, blog platform, etc.) and mediated between the advertiser 110 and the influencer 310 based on the analysis result.

In one embodiment, the influencer mediation service providing device 200 may mediate between the advertiser 110 and the influencer 310 by analyzing the activities of the influencer 310 registered in the corresponding system, and the advertiser 110 and the influencer 310 may be brokered by analyzing the activities of the influencer 310 not registered in the system. For example, the influencer mediation service providing device 200 may collect the contents of the influencer 310 registered in the platform system server 400 and analyze the activity of the influencer. When the advertiser and the influencer are matched, the influencer mediation service providing device 200 may manage the process of requesting an advertisement and performing the advertisement.

When an advertisement is requested to the influencer 310 and the influencer uploads the advertisement to the platform system server 400, the influencer mediation service providing device 200 monitors the advertising activity of the influencer for which the advertisement is requested and suggests advertising strategies to advertisers based on the monitoring results. In one embodiment, the influencer mediation service providing device 200 may be implemented as a server.

Therefore, the influencer mediation service providing device 200 according to an embodiment may be implemented as a server, and it may be processed by a web server, a virtual server such as a cloud server, a control module of a computing device such as a smartphone, tablet PC, or desktop PC and configured to be stored in a memory module of each device.

The influencer mediation service providing device 200 may further include a storage unit (not shown) capable of storing various types of information. The storage unit may store data received by the apparatus 200 for providing mediation services for influencers, data generated during the operation of the apparatus 200 for providing mediation services for influencers, and result data. For example, information on the advertiser received from the advertiser terminal device 100, information on the influencer 300 received from the influencer terminal device 100, and advertising activity information of the influencers 300 collected from the platform system server 400 and feedback information thereof may be converted into data and stored in a storage unit for management.

The influencer terminal device 300 can access the influencer mediation service providing device 200 under the control of the influencer, register basic information of the influencer, or search advertisement request information for advertisements requested from advertisers.

In addition, the influencer terminal device 300 may create content and upload it to the platform system server 400 under the influencer's control. For example, the influencer terminal device 300 may create a video or create a blog post or social media post under the influencer's control and upload it to the platform system server 400.

Accordingly, the influencer terminal device 300 according to an embodiment includes a computing device capable of accessing the influencer mediation service providing device 200 through a dedicated application or a general-purpose application. For example, the computing device can include PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smartphone, smartpad, tablet PC, smart watch (It may include all kinds of handheld-based wireless communication devices such as smart watches, smart glasses, and wearable devices.

The platform system server 400 may register and manage content created by a corresponding platform user. Contents registered in the platform system server 400 may be shared or viewed by other users. For example, advertisement content registered in the platform system server 400 by an influencer may be shared with account-linked users (eg, followers) of the influencer.

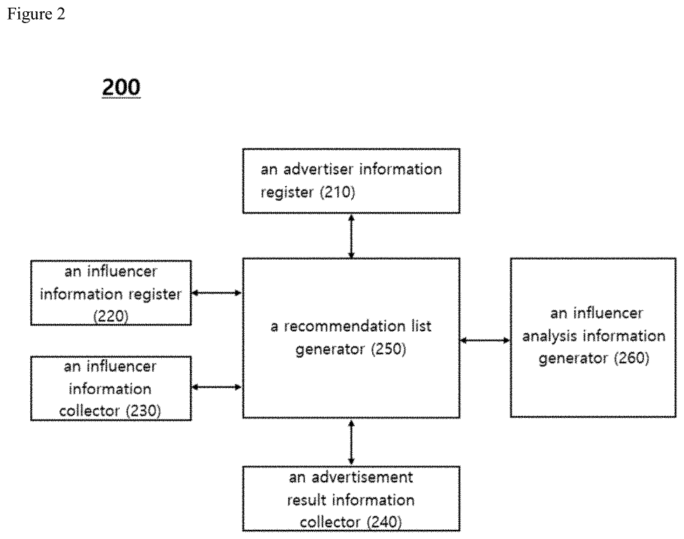

FIG. 2 is a block diagram showing some components of the influencer mediation service providing apparatus 200 according to an embodiment.

Referring to FIG. 2, the influencer mediation service providing device 200 includes an advertiser information register 210, an influencer information register 220, an influencer information collector 230, and an advertisement result information collector 240, a recommendation list generator 250 and an influencer analysis information generator 260.

The advertiser information register 210 may receive information about a product or service that the advertiser wants to advertise and basic personal information about the advertiser from the advertiser and register the collected information.

The product information may include price information, origin information, effect information, etc. of the product to be advertised, and information about the advertiser may store basic personal information about the advertiser. In addition, information on the advertiser's preferred influencer, platform information, and advertiser's preferred advertising style may be included. This information can be used as basic information when the list generator 250 provides a list of recommended influencers to advertisers later.

The influencer information register 220 may register the influencer by receiving basic information from the influencer requesting the mediation service providing device 200 to register the influencer.

In another embodiment, the influencer register 220 may search for influencers on each platform, send a registration request message to the influencer, receive basic information from the influencer, and register the information. Basic information may include at least one of an activity platform, platform account information, contact information, and an influencer mediation system access ID and password. Furthermore, it can include the influencer's preferred platform, posting style, activity area, type of shooting device, body information, skin information, job information, pet ownership, frequently used keywords and information about interests.

In addition, the information registered in the influencer information register 220 may include information on products preferred by the influencer or information on advertisers preferred by the influencer. In addition, it may include information on a preferred platform or advertising method and may include information on products or services that the influencer thinks are suitable for the individual. The information collected in this way can be used as basic information when the recommendation list generator 250 provides a list of recommended influencers to advertisers later.

The influencer information collector 230 collects activity information of each influencer by crawling content posted by registered influencers by platform. For example, the information collection collector 230 can collect activity information of the influencer based on the influencer's account information, such as the influencer's social media account (eg Instagram, Facebook) information, blog account information, or video site account information.

Specifically, the influencer information collector 230 may collect content through a crawler, for example, and store the collected content in a storage unit (not shown). The influencer information collector 230 may collect activity information of influencers according to a preset analysis method and classification method for stored content. In one embodiment, the activity information includes at least one of the influencer's number of posting contents for each platform, amount of activity for each platform, content category, content content, content format, activity period, and feedback information about advertisements for the influencer (e.g., rating information). or comment information).

In addition, the influencer information collector 230 may classify the categories of contents posted in each menu through a blog menu, for example, or classify the categories of contents based on tag information included in the contents. Alternatively, the influencer information collector 230 may classify the category of the content by recognizing images, videos, or text (eg, keywords or sentences stored in advance) included in the content.

In addition, the influencer information collector 230 can extract images, videos, or text included in the content to make a database of content posted by the corresponding influencer, and the components constituting the content (eg, image, video, text, etc.) and the arrangement of components can be analyzed to analyze the content format frequently used by the influencer.

The advertisement result information collector 240 may collect various information related to the content posted by the influencer for the product requested by the advertiser and transmit the collected information to the advertiser terminal device 100.

Specifically, the advertisement result information collector 240 monitors the advertisement activity result of the influencer selected by the advertiser and at the same time monitors the results of advertising activities by receiving monitoring information from the monitoring code embedded in the advertisement content posted by the influencer.

The advertisement activity result information may include an advertisement activity amount for each platform, advertisement details for each product or service category, and advertisement effect for each product or service. For example, information on the number of visits to the advertisement content, the number of views, and sales of products or services that have passed through the platform of the influencer may be included.

As an embodiment, the advertisement result information collector 240 may issue a monitoring code to the influencer and provide it to the influencer terminal device 100 after the advertiser's advertisement request and the influencer's advertisement request are approved.

In addition, the advertisement result information collector 240 collects feedback from other users associated with the content posted by the influencer. And the amount of feedback and the content of the feedback (eg, feedback tendency (positive or negative), etc.) can be collected by the advertisement result information collector 240. In one embodiment, the feedback tendency may be manually classified and input by the operator of the influencer mediation service providing device 200 or may be automatically classified according to whether trend-related words are included or not.

The amount of feedback and the content of the feedback may be used later by the influencer analysis information generator 260 to generate information about the influencer's feedback trend by content category, feedback trend by content content, or feedback by content format in connection with the content category, content content, or content format. In addition, this information can be used as feedback information necessary for the recommendation list generator 250 to generate an influencer recommendation list using artificial intelligence.

As another embodiment, the advertisement result information collector 240 may collect information in real time, such as the advertisement effect of advertisement contents posted by the influencer to the platform system server 400, for example, the number of visits to the advertisement contents, the number of hits, etc and provide the collected information to the terminal device 100. The collected information may be provided to the advertiser terminal device 100 without special processing and may be provided to the advertiser terminal device 100 as a result of various analysis through the influencer analysis information generator 260. Details of the influencer analysis information generator 260 will be described later.

In addition, the advertisement result information collector 240 may collect mutual evaluation information on the advertiser and the influencer who advertised for a specific actual product or service. In other words, advertisers can collect comprehensive evaluation information (e.g., sales satisfaction, communication satisfaction, satisfaction by platform, promotion effect satisfaction, comprehensive evaluation score, etc.). Conversely, influencers can also collect comprehensive evaluation information (e.g., cost satisfaction, revenue satisfaction, communication satisfaction, and overall evaluation score) for advertisers. And this information can be used as feedback information when the recommendation list generator 250 creates a list of recommended influencers.

The recommendation list generator 250 may create an influencer recommendation list most suitable for the advertiser based on the information collected by the advertiser information register 210, the influencer information register 220, and the influencer information collector 230 and the advertisement result information collector 240 when advertisement target product or service information is received from the advertiser terminal device 100 and transmit the created list to the advertiser terminal device 100.

Specifically, the recommendation list generator 250 may generate an influencer recommendation list based on information on advertisement effectiveness of influencers for the same/similar product or service collected through the advertisement result information collector 240. For example, the recommendation list generator 250 can create a recommendation list with the influencer's highest number of visits to the corresponding platform, the highest number of views, and the highest number of feedback (eg, comments, retweets, ‘likes’, etc.).

Also, according to an embodiment, the recommendation list generator 250 includes an artificial neural network module 251. Therefore, in generating the influencer recommendation list, deep learning may be performed using an artificial intelligence neural network, and then the recommendation list may be generated and provided to the advertiser. Let's look at this in detail through the drawings below.

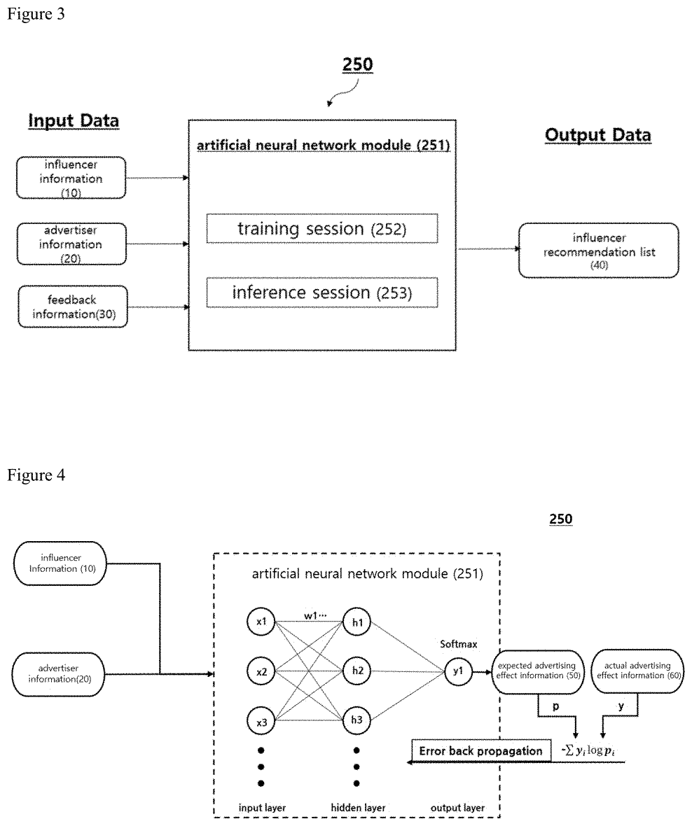

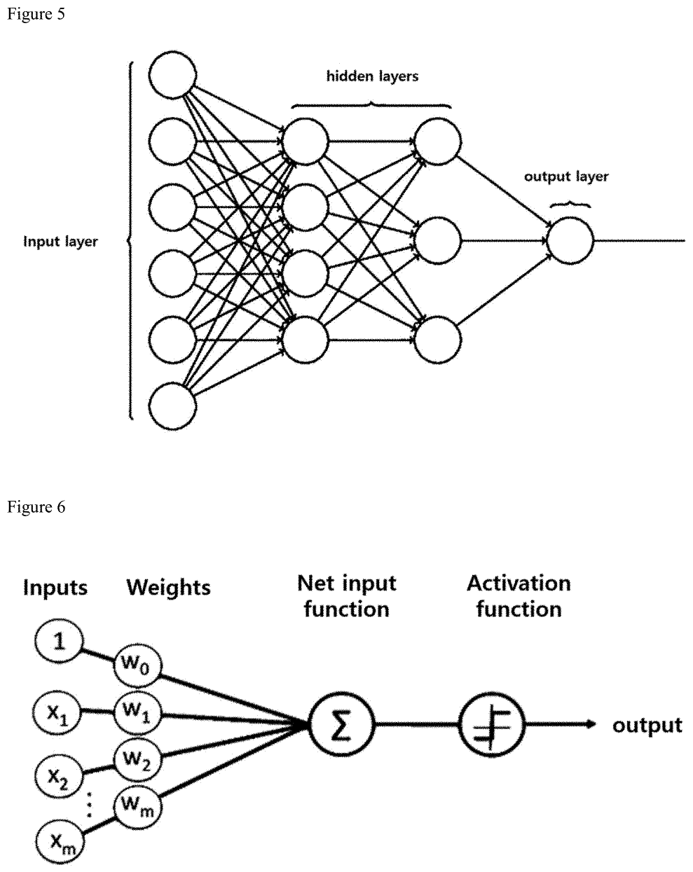

FIGS. 3 and 4 are diagrams illustrating some components of the artificial neural network module 251, input data, output data, and feedback information input to the artificial neural network module 251 according to an embodiment.

Specifically, the artificial neural network module 251 may include a training session 252 for training on how to select an influencer suitable for an advertiser and an inference session 253 where inference is made on how to select the most appropriate influencer for the advertiser based on the results learned in the training session 252.

Specifically, the training session 252 may perform learning on how to select an influencer most suitable for an advertiser based on information about advertisers and influencers and past advertisement activity information of influencers.

For example, the training session 252 may perform learning by analyzing information on past advertising effects to learn about matching results that actually have the best advertising effects after classifying advertisers and influencers into a plurality of groups, each group is matched with each other.

A method of classifying advertisers and influencers into a plurality of groups can be classified according to various criteria based on information registered in the advertiser information register 210 and the influencer information register 220 described above.

A neural network model used in the artificial neural network module 251 is a supervised learning algorithm derived from the structure of neurons in biology.

The basic operating principle of a neural network model is to predict an optimal output value for an input value by interconnecting several neurons. From a statistical point of view, a neural network model can be viewed as a projective tracking regression that takes a non-linear function over a linear combination of input parameters.

As shown in FIG. 4, each attribute constituting the influencer information 10 and the advertiser information 20 can be entered into each node of the input layer of the artificial neural network module 251, such as x1, x2, and x3. The input information goes through a weight-based hidden layer and a cost function such as softmax or ReLU and is finally output as information on the influencer recommendation list 40. In the information on the influencer recommendation list 40 may include prediction results (e.g., the number of likes, the number of positive or negative comments, the number of influencers who commissioned the advertisement) that may occur when a specific product or service is advertised to a specific influencer information on sales etc.

In addition, the artificial neural network module 251 may perform feedback based on actual information collected through the advertisement result information collector 240 after a certain period has elapsed for information on the advertisement effect of the influencers in the current recommendation list 40.

Specifically, as shown in FIG. 4, Back propagation can proceed as a method of updating the weight of the hidden layer to reduce the error (error, −Sigma (yi log pi)) based on the expected advertising effect information 50 and the actual advertising effect information 60.

For example, if an advertiser belonging to group A is matched with an influencer belonging to group X, but the actual advertising result is not better than the predicted result, the weight can be updated by reducing this error. Conversely, if an advertiser belonging to group B is matched with an influencer belonging to group Y, and the actual advertising result is better than the predicted result, feedback can be performed by increasing the weight of the weight of the hidden layer.

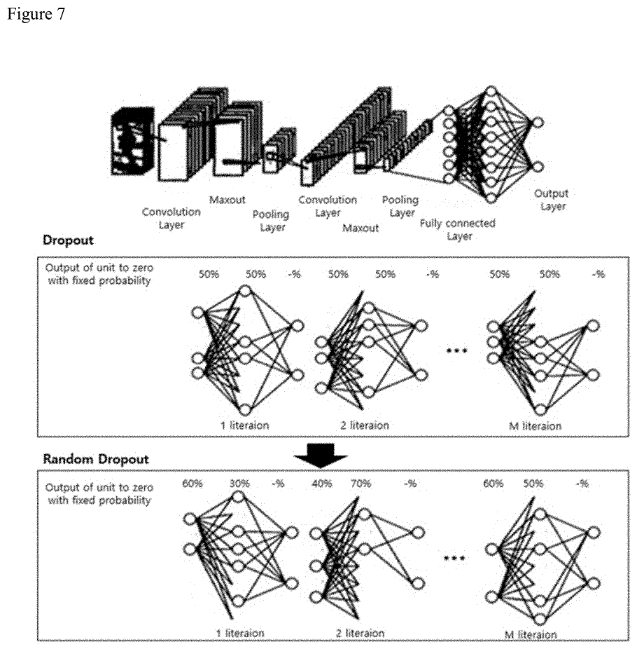

FIG. 5 is a schematic diagram showing the structure of a multi-layer neural network model (deep learning or deep neural network model) in relation to the specific structure of the artificial neural network module 261 according to an embodiment of the present invention.

As shown in FIG. 5, the multilayer neural network model of the artificial neural network module 261 according to an embodiment of the present invention may be composed of an input layer, a hidden layer, and an output layer.

The input layer is composed of nodes corresponding to each input factor, and the number of nodes is equal to the number of input factors. The hidden layer may serve to process a linear combination of factor values transmitted from the input layer into a non-linear function such as a sigmoid function and transmit the result to an output layer or another hidden layer. The output layer may generate a node corresponding to an output factor. And in a classification model, as many output nodes as the number of classes can be generated.

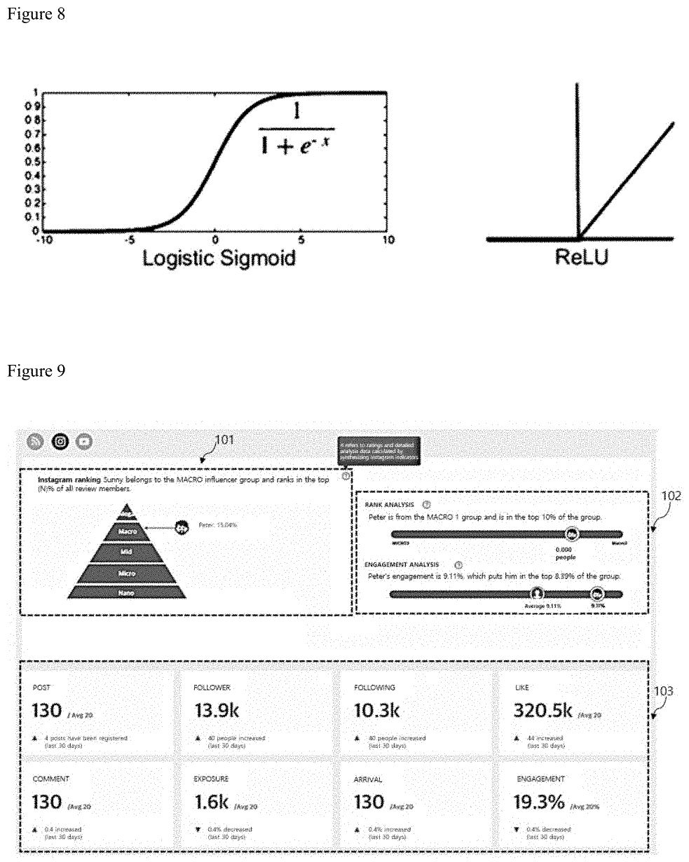

FIG. 6 is a schematic diagram showing a calculation process at a node of the artificial neural network module 261 according to an embodiment of the present invention.

As shown in FIG. 6, calculation occurs at each node actually, and this calculation process is mathematically designed to simulate a process occurring in neurons constituting a human neural network.

A node responds when it receives a stimulus of a certain size or more, and the size of the response is proportional to the value obtained by multiplying the input value and the node's coefficient (or weights), excluding the bias value. In general, a node receives multiple inputs and has as many coefficients as the number of inputs. Therefore, by adjusting this coefficient, different weights can be given to different inputs. Finally, the multiplied values are all added up, and the sum goes into the input of the activation function. The result of the activation function corresponds to the output of the node, and this output value is ultimately used for classification or regression analysis.

Each layer of the neural network model is composed of at least one node, and activation/deactivation of each node is determined according to an input value. The input information becomes the input of the first layer (input layer), and then the output of each layer becomes the input of the next layer. All coefficients change based on which inputs each node considers important. And ‘training’ of the neural network model is the process of updating these coefficients.

Overfitting problems occur in multilayer neural network models. Overfitting occurs when the complexity of the model is high compared to the amount of information given, and the complexity of the model increases exponentially as the neural network deepens.

Therefore, recently, new initialization methods such as RBM (Restricted Boltzmann Machine) and CNN (Convolutional Neural Network) have been proposed to solve this problem.

In particularly, RBM is used as a component of DBN (Deep Belief Network), and overfitting can prevent by effectively pre-training each layer of the feedforward neural network to be trained through an unsupervised RBM (restricted Boltzmann machine). Then, learning proceeds again in the form of using supervised back propagation. Recently, the drop-out method is widely used as part of random initialization.

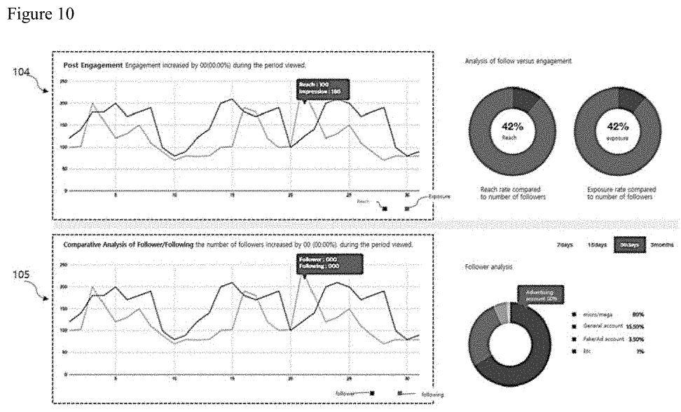

FIG. 7 is a schematic diagram showing a drop-out method of the artificial neural network module 251 according to an embodiment of the present invention.

As shown in FIG. 7, the drop-out method of the artificial neural network module 300 according to an embodiment of the present invention uses only about 50% of neurons in the hidden layer instead of all neurons in each training. In one deep learning, several small neural networks have the effect of being ensemble, and the ensemble can reduce overfitting. In addition, since neurons with similar weights are reduced, neurons making redundant judgments are reduced, so neurons can be used efficiently.

In addition, recently, an activation function called Rectified Linear Unit (ReLU) has been used to solve problems such as slow learning time and overfitting, and FIG. 6 is a graph showing the ReLU activation function.

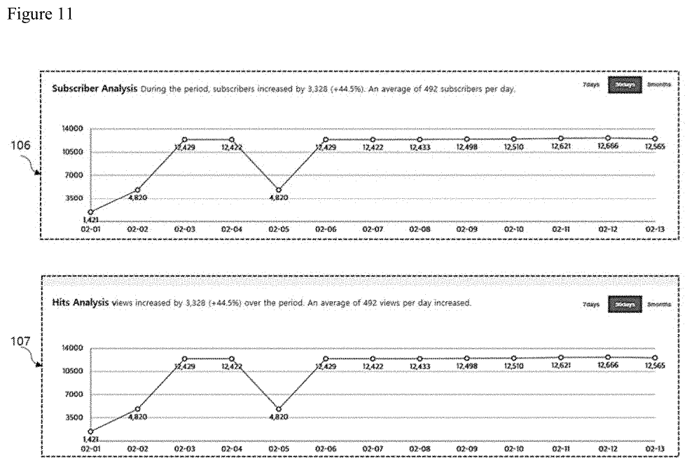

As shown in FIG. 8, the existing sigmoid function has a problem of disappearing errors every time gradient descent is performed in several layers. As the sigmoid function go through several layers and reach the limit, the gradient of the sigmoid function becomes smaller, causing a problem that the weights are not updated. However, when using the ReLU function as an activation function, since the slope is used as 0 or 1, the error is propagated to 100% and this problem can be solved.

Since the ReLU function is not limited to [0,1] like sigmoid and its range is unlimited, it can be seen as having more accurate expression power. In addition, there are many unnecessary values among the output values of each node. In this case, when using the sigmoid function, it is necessary to calculate all values, but the ReLU function can reduce a large part of the amount of calculation, resulting in an effect of improving the computing speed. Regularization can be improved by the ReLU function.

Returning to FIG. 2 and explaining the influencer analysis information generator 260, the influencer analysis information generator 260 may generate comprehensive information on the influencer based on the information collected by the influencer information register 220, the influencer information collector 230, the advertisement Based on the information collected by the resultant information collector 240 and transmit the generated information to the advertiser terminal device 10.

Specifically, the influencer analysis information generator 260 may generate analysis information by analyzing the activity of each influencer based on the basic information of the influencer, the collected activity information, and the advertisement history information. For example, the influencer analysis information generator 260 may generate analysis information by analyzing information on the influencer's body condition (eg, gender, height, weight, body part (confident body) body parts or frequently exposed body parts), etc.), major activity medium, number of account-linked users (eg, followers, etc.), number of content visits or views (eg, number of visits, period average number of visits, views, period average number of views) etc.) based on the influencer's basic information and activity information.

In addition, the influencer analysis information generator 260 may generate analysis information by analyzing at least one of (for example, the number of visits to the advertisement content, the number of views, the number of feedbacks, and the feedback trend), the advertisement effect compared to the cost for each product or service and the influencer's advertising activity by platform, major advertising platform, advertising history by product or service category, and advertising effect by product or service based on the influencer's advertising history information.

In addition, the influencer analysis information generator 260 analyzes at least one of the numbers of content feedbacks (eg, comments, retweets, ‘likes’, etc.) and feedback tendencies (eg, positive or negative) and generate the analysis information. In one embodiment, the body condition may be input in advance as basic information or may be acquired through content analysis of content posted by an influencer.

And the information generated by the influencer analysis information generator 260 described so far can be transmitted to the recommendation list generator 250. And the recommendation list generator 250 may generate a list of recommendation of the most appropriate influencers for the advertiser based on this information.

In addition, the information generated through the recommendation list generator 250 and the influencer analysis information generator 260 may be stored in a storage unit (not shown) in association with the corresponding influencer. When an inquiry or information request for an influencer is received from the advertiser terminal device 100, the influencer mediation service providing device 200 may provide the result of analysis of the influencer to the advertiser terminal device 100.

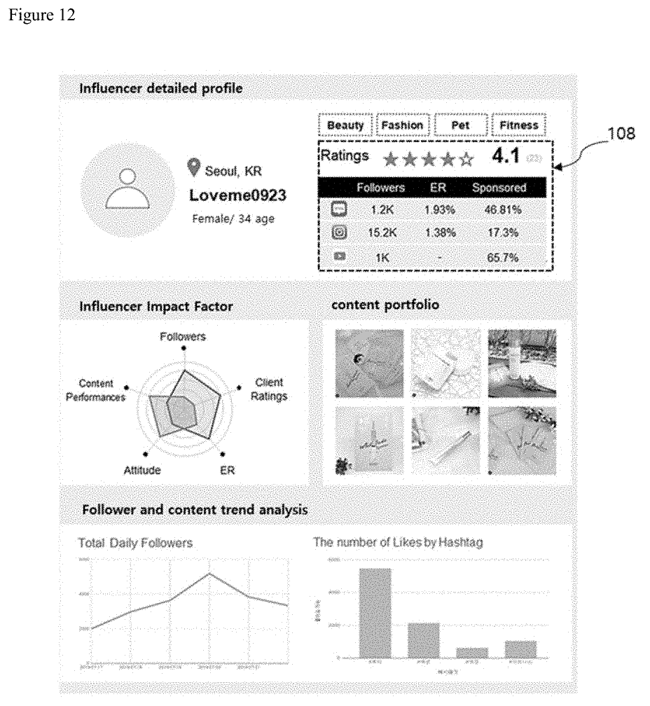

FIGS. 9 to 12 are views showing an example of information provided to an advertiser in an advertiser and influencer mediation system using artificial intelligence according to an embodiment, and specifically, it is a diagram showing examples in which the generated information of the influencer analysis information generator is displayed on the advertiser terminal device 100.

In generating the influencer analysis information, the influencer analysis information generator 260 may compare information about a specific influencer with all influencers registered in the influencer information register 220 and may generate visually displayed information and transmit the visually displayed information to the advertiser terminal device 100.

For example, as shown in FIG. 9, on the display of the advertiser terminal device 100, which group a specific influencer currently belongs to is visually displayed 110 using a pyramid-shaped figure among all groups, it may be displayed 120 using a line, and information on absolute numerical values for each item 130 may also be displayed. As shown in FIG. 9, if comparative information about where the current influencer is located within the entire group is visually presented to the advertiser, the advertiser has the advantage of being able to select the influencer that suits their taste more easily.

In addition, the influencer analysis information generator 260, as shown in FIGS. 9 and 10, generates information about various information about a specific influencer, for example, post participation information 104, follower/following comparison analysis information 105, subscriber information 106, and inquiry number information 107 as a graph over time and transmit the information to the advertiser terminal device 100.

If information is provided over time to advertisers, as shown in FIGS. 9 and 10, rather than simply providing information in absolute numbers, advertisers can determine whether the influence of a specific influencer is increasing or decreasing. There is an advantage that advertisers can easily find information, so they can choose an influencer that suits their taste.

In addition, as shown in FIG. 12, the influencer analysis information generator 260 may generate ranking information for each platform for a specific influencer as comparison information 108 and provide it to the advertiser. If ranking information is provided for each platform as shown in FIG. 12 rather than simply providing information in absolute numbers, advertisers can easily know which influencer is ranked high on their preferred platform. So there are advantages to choosing an influencer that suits advertiser's taste.

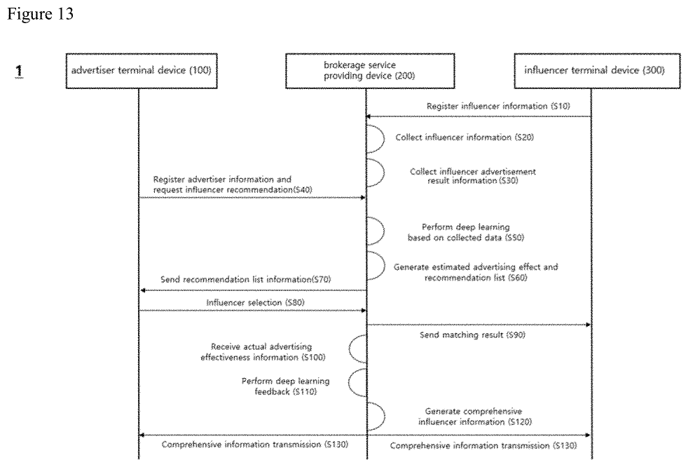

FIG. 13 is a flowchart illustrating an operation flow of an advertiser and influencer mediation system using artificial intelligence according to an embodiment.

Referring to FIG. 13, an influencer may register various information, including personal information, in the mediation service providing device 200 through the influencer terminal device 300. (S10)

When information about an influencer is registered, the mediation service providing device 200 may collect various information about the influencer's activity by platform and collect advertising results accordingly. (S20, S30) A detailed description thereof will be omitted as it has been described above with reference to FIG. 2.

Meanwhile, the advertiser may register the advertiser's information in the mediation service providing device 200 through the advertiser terminal device 100 and request an influencer recommendation to advertise a specific product or service. (S40)

Upon receiving an influencer recommendation request from the advertiser terminal device 100, the mediation service providing device 200 performs deep learning based on information about advertisers and information about influencers and calculates expected advertising effects. Based on this, the mediation service providing device 200 generates a recommendation list. (S50, S60) A detailed description thereof will be omitted as it has been described in FIGS. 3 and 4.

The mediation service providing device 200 transmits the generated recommendation list information to the advertiser terminal device, and when the advertiser selects an influencer to advertise through the advertiser terminal device 100, the matching result is transmitted to the influencer's terminal device 300. (S70—S90)

Thereafter, the mediation service providing apparatus 200 may collect information on actual advertisement effect of an influencer advertising a product or service requested by an advertiser and perform feedback deep learning based on the collected information. (S100, S110)

Thereafter, the service providing device 200 may generate comprehensive and diverse information about the influencer and transmit the generated information to the advertiser terminal device 110 and the influencer terminal device 300.

So far, the features of the present invention have been looked at in detail through the drawings.

Device for providing mediation service between advertiser and influencer by using artificial intelligence, and mediation method using same according to an embodiment, unlike the prior art, provide an optimal influencer suitable for advertisers based on information about advertisers and information about influencers, there is an advantage that can maximize the advertising effect of communicating with influencers.

In addition, in generating the recommended influencer list, the present invention updates the algorithm reflecting the feedback information on the actual advertisement effect using artificial intelligence technology, not the same algorithm, and then uses the updated algorithm to recommend the recommended influencer. Since an announcer list is created, there is an effect of mediating influencers that are more suitable for advertisers.

In addition, in providing analyzed information about influencers to advertisers, information that changes over time and comparison information with other influencers is also provided, not singular numbers, so there are advantages for advertisers to choosing an influencer prefer more.

On the other hand, components, units, modules, components, etc. described in this specification described as “— unit” may be implemented together or separately as interoperable logic devices. Depiction of different features for modules, units, etc. is intended to highlight different functional embodiments and does not necessarily mean that they must be realized by separate hardware or software components. Rather, functionality associated with one or more modules or units may be performed by separate hardware or software components or integrated within common or separate hardware or software components.

Although acts are depicted in the drawings in a particular order, it should not be understood that these acts need to be performed in the particular order shown, or in a sequential order, or that all depicted acts need to be performed to achieve a desired result. In some circumstances, multitasking and parallel processing may be advantageous. Moreover, it should not be understood that the division of various components in the above-described embodiments should not be understood as requiring such division in all embodiments. So it should be understood the described components may generally be integrated together into a single software product or packaged into multiple software products.

Terminal device programs (also known as programs, software, software applications, scripts, or code) may be written in any form of programming language, including compiled or interpreted languages or a priori or procedural languages, and may be stand-alone programs or modules, components, subroutines, or other units suitable for use in a terminal device environment.

Additionally, the logic flow and structural block diagrams described in this patent document describe corresponding actions and/or specific methods supported by corresponding functions and steps supported by the disclosed structural means. It can also be used to build software structures and algorithms and their equivalents.

The processes and logic flows described herein can be performed by one or more programmable processors executing one or more terminal device programs to perform functions by operating on input data and generating output.

The present description presents the best mode of the invention and provides examples to illustrate the invention and to enable those skilled in the art to make and use the invention. The specification thus prepared does not limit the invention to the specific terms presented.

Although the above has been described with reference to preferred embodiments of the present invention, those skilled in the art or those having ordinary knowledge in the art do not deviate from the spirit and technical scope of the present invention described in the claims to be described later. It will be understood that the present invention can be variously modified and changed within the scope not specified.

Therefore, the technical scope of the present invention should not be limited to the contents described in the detailed description of the specification but should be defined by the claims.

1. A device for providing mediation service between advertiser and influencer by using artificial intelligence comprising:
an advertiser information register that receives information about an advertiser;
an influencer information register that receives information about an influencer;
an influencer information collector that collects activity information of the influencer by crawling the contents posted by the influencer for each platform;
an advertisement result information collector that collects advertisement result information of the influencer and evaluation information on the influencer;
a recommendation list generator that generates an influencer recommendation list suitable for the advertiser and provides it to the advertiser based on the information collected by the advertiser information register, the influencer information register, the influencer information collector and the advertisement result information collector; and
an influencer analysis information generator generating comprehensive information on the influencers in the recommendation list based on the information collected by the influencer information register, the influencer information collector, and the advertisement result information collector and generating information by comparing the comprehensive information with all influencers registered in the influencer information register, classifying the compared information by platform, and generating information about the progress of time,
wherein the recommendation list generator includes,
an artificial neural network module for learning based on influencer information and advertiser information as input information, expected advertisement effect information as output information, and using the expected advertisement effect information and actual advertisement effect information as a loss function,
wherein the actual advertisement effect information includes advertisement activity information and evaluation information collected by the advertisement result information collector,
wherein the recommendation list generator generates the recommendation list based on expected advertisement effect information output from the artificial neural network module in generating the recommendation list,
wherein the comprehensive information includes at least one of body information of the influencer on the recommendation list, information on the number of account-linked users, information on the number of content views and feedback, information on the amount of advertisement activity by platform, and advertisement details and effect information by product or service,
wherein the advertisement activity information includes at least one of advertisement activity amount information for each platform, advertisement detail information for each product or service category, and advertisement effect information for each product or service.

2-4. (canceled)

5. The device for providing mediation service between advertiser and influencer by using artificial intelligence of claim 1,
wherein the influencer information register is registered an information about at least one of information on the influencer's preferred platform, posting style, activity area, type of filming device, body information, skin information, job information, whether a companion animal is owned, and frequently used key keywords and interests.

6. The device for providing mediation service between advertiser and influencer by using artificial intelligence of claim 1,
wherein the recommendation list generator calculates expected advertisement effects for each influencer or platform for a product or service to be advertised and creates a list of recommended influencers in order of highest expected advertisement effect.

7-8. (canceled)
